(19) United States
(12) Patent Application Publication
(10) Pub. No.: US 2017/0177759 A1
(43) Pub. Date: Jun. 22, 2017

(54) METHOD AND APPARATUS FOR MODELING MOVEMENT OF TARGET OBJECT BY INTERACTION WITH FLUID

(71) Applicant: Samsung Electronics Co., Ltd., Suwon-si (KR)

(72) Inventors: Jiyeon KIM, Hwaseong-si (KR); Nahyup KANG, Seoul (KR); Donghoon SAGONG, Suwon-si (KR); Hyong Euk LEE, Suwon-si (KR); Hwiryong JUNG, Seoul (KR)

(73) Assignee: Samsung Electronics Co., Ltd., Suwon-si (KR)

(21) Appl. No.: 15/286,847

(22) Filed: Oct. 6, 2016

(30) Foreign Application Priority Data
Dec. 22, 2015 (KR) 10-2015-0183983

(51) Int. Cl. G06F 17/50; G06F 17/11

(52) U.S. Cl. CPC G06F 17/5009; G06F 17/11; G06F 2217/16

(57) ABSTRACT

Provided is a method and apparatus for modeling a movement of an object that generates a velocity field in a fluid based on a flow of the fluid, selects a vortex model corresponding to the object in the fluid, updates the velocity field based on a velocity variance of the velocity field obtained using the vortex model, and models a movement of the object based on the updated velocity field.

### CROSS-REFERENCE TO RELATED APPLICATION(S)

This application claims the benefit under 35 USC §119(a) of Korean Patent Application No. 10-2015-0183983, filed on Dec. 22, 2015, in the Korean Intellectual Property Office, the entire disclosure of which is incorporated herein by reference for all purposes.

### BACKGROUND

1. Field

The following description relates to a method and apparatus for modeling a movement of a target object by interaction with a fluid.

2. Description of Related Art

A height field-based fluid movement modeling scheme is used in real-time fluid modeling. The height field-based fluid movement modeling scheme performs simple modeling and fast calculation, but it provides simplified fluid expression and deterioration in realistic effects.

Schemes of reproducing a fluid phenomenon through full three-dimensional (3D) modeling divide a 3D particle or a grid and obtain a solution of a Navier-Stokes equation at a corresponding sample point. Such schemes may physically reproduce a correct fluid phenomenon, however, these schemes may not perform real-time modeling due to the complexity of needed computation.

In computer graphics, a scene in which a fluid and a target object interact and influence each other is generally provided, but it is difficult to model such interaction in real time.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method of modeling a movement of an object, the method including generating a velocity field in a fluid based on a flow of the fluid, selecting a vortex model corresponding to the object in the fluid, updating the velocity field based on a velocity variance of the velocity field obtained using the vortex model, and modeling a movement of the object based on the updated velocity field.

The generating of the velocity field may include generating the velocity field based on a flow of a surface of the fluid obtained from a result of modeling using a height field scheme.

The generating of the velocity field may include expressing the fluid as two-dimensional (2D) grid cells using the height field scheme, measuring a variance in height of each of the 2D grid cells of the fluid, ascertaining a surface velocity field of the each of the 2D grid cells of the fluid based on the variance in height, and determining the velocity field in the fluid based on the surface velocity field.

The generating of the velocity field may include defining a thickness of a boundary layer of the fluid based on at least one of a viscosity, a density, a velocity, or an overall scale of the fluid, and generating the velocity field in the fluid from the surface velocity field based on the thickness of the boundary layer of the fluid.

The selecting of the vortex model may include selecting the vortex model in association with a position of the target object based on at least one of a shape or a size of the target object.

The selecting of the vortex model may include determining at least one of a position or an intensity of the vortex model based on a relative velocity of the fluid with respect to the movement of the target object.

The selecting of the vortex model may include selecting the vortex model using at least one of a curl noise scheme that virtually models fluid turbulence or a Karman vortex street scheme that models a repeating pattern of vortices.

The updating of the velocity field may include updating the velocity field by applying the velocity variance to a position of the object in the velocity field.

The updating of the velocity field may include updating the velocity field based on the velocity variance using a Gaussian distribution with respect to the target object.

The method may include calculating the velocity variance of the velocity field using the vortex model.

The method may include receiving a fluid boundary condition, and modeling the fluid using a height field scheme based on the fluid boundary condition.

In another general aspect, there is provided an apparatus for modeling a movement of an object, the apparatus including a processor configured to generate a velocity field in a fluid based on a flow of the fluid, select a vortex model corresponding to the object in the fluid, and model a movement of the object based on the velocity field, the velocity field being updated based on a velocity variance of the velocity field obtained using the vortex model.

The processor may be configured to generate the velocity field based on a flow of a surface of the fluid obtained from a result of modeling using a height field scheme.

The processor may be configured to express the fluid as two-dimensional (2D) grid cells using the height field scheme, to measure a variance in height of each of the 2D grid cells of the fluid, to ascertain a surface velocity field of the each of the 2D grid cells of the fluid based on the variance in height and to determine the velocity field in the fluid based on the surface velocity field.

The processor may be configured to generate the velocity field in the fluid from the surface velocity field based on a thickness of a boundary layer of the fluid, the thickness of the boundary layer being defined based on at least one of a viscosity, a density, a velocity, or an overall scale of the fluid.

The processor may be configured to determine at least one of a position or an intensity of the vortex model based on a relative velocity of the fluid with respect to the movement of the object.

The processor may be configured to update the velocity field by applying the velocity variance to a position of the object.

The processor may be configured to update the velocity field based on the velocity variance using a Gaussian distribution with respect to the object.

The apparatus may include a receiver configured to receive a fluid boundary condition, wherein the processor may be configured to model the fluid using a height field scheme based on the fluid boundary condition.

Other features and aspects will be apparent from the following detailed description, the drawings, and the claims.

### BRIEF DESCRIPTION OF THE DRAWINGS

FIG. 1 illustrates an example of interaction between a fluid and a target object.

FIG. 2 illustrates an example of a process of transferring an influence of interaction between a fluid and a target object to the target object.

FIG. 3 is a diagram illustrating an example of a method of modeling a movement of a target object.

FIG. 4 is a diagram illustrating an example of a method of generating a velocity field in a fluid.

FIG. 5 illustrates an example of a three-dimensional (3D) fluid expressed as two-dimensional (2D) grid cells using a height field scheme.

FIG. 6 illustrates an example of a method of calculating a velocity field in a fluid based on a surface velocity field.

FIGS. 7 and 8 illustrate examples of vortex models being selected.

FIG. 9 is a diagram illustrating an example of a method of modeling a movement of a target object.

FIG. 10 illustrates an example of a method of modeling a movement of a target object.

FIG. 11 is a diagram illustrating an example of an apparatus for modeling a movement of a target object.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

The following description may be used to generate a movement of contents through physics-based modeling when creating visual contents. The following description may be implemented as various types of products, for example, personal computers, laptop computers, tablet computers, smartphones, smart televisions, smart home appliances, intelligent vehicles, and wearable devices. The following description may be utilized as element technology for various applications in a game engine or a physical engine, and implemented as a native code to be utilized when creating movies or broadcast contents. The examples may also be utilized to reproduce visual contents in hardware including a display device such as, for example, digital televisions (DTV), smartphones, and tablets.

In addition, following description may operate in a mobile device or a computer to model a realistic movement of a target object in an image displaying application of the mobile device or the computer. The examples described below may receive a force to enable a target object to move through interoperation with an external user control. In an example, the target object may be moved based on a movement of a head in a head-mounted display (HMD), or a movement of the target object may be modeled based on a control input received through a joystick. In the foregoing manner, the examples described below may be utilized for virtual reality or augmented reality.

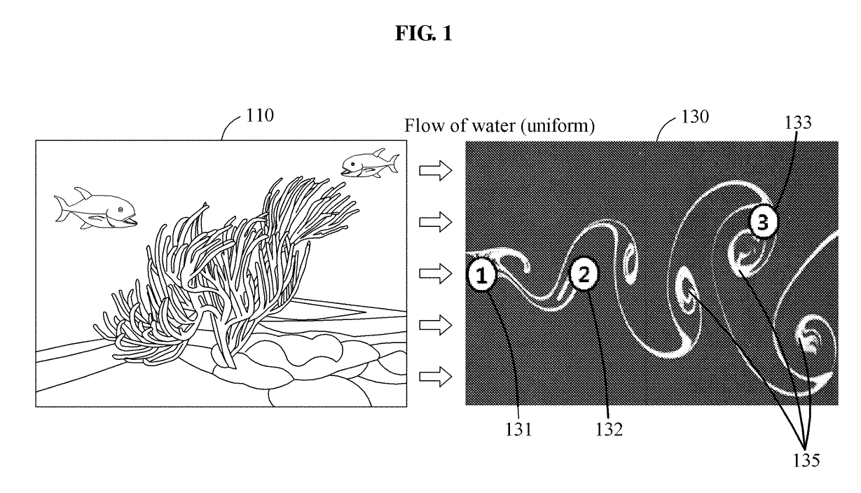

FIG. 1 illustrates an example of interaction between a fluid and a target object. FIG. 1 illustrates a scene 110 in which a fluid and target objects interact with each other, and an image 130 showing vortices occurring in the fluid in response to the interaction between the fluid and the target objects.

In an example, a situation in which an aquatic plant and fish interact with each other in the water is shown in the scene 110. In this example, the aquatic plant has a number of branches. Each branch moves at freedom in response to a velocity of flow, and is influenced by movements of the fish moving around the aquatic plant. The fish are influenced by both the velocity of flow and a velocity of flow changing in response to the movements of the aquatic plant and neighboring fishes. Thus, turbulence or a vortex phenomenon occurs in the water due to the movements of the aquatic plant and the fish.

In the image 130, target objects 131, 132, and 133 moving in the fluid, for example, the water, and vortices 135 occurring in response to interaction between the target objects 131, 132, and 133 and the fluid are illustrated. For example, in the image 130, it is assumed that the fluid flows uniformly from left to right as shown by the arrows, and only the first target object 131 exists in the fluid. In this example, the vortices 135 occur in response to the interaction between the fluid and the first target object 131. Here, when assuming that the second target object 132 or the third target object 133 coexists with the first target object 131, a movement of the second target object 132 or the third target object 133 may be influenced by the vortices 135 occurring in response to the interaction between the first target object 131 and the fluid.

In scene 110 which depict target objects, such as, for example, the aquatic plant and the fish, and the fluid such as the water influence movements of each other, movements or deformations of the target objects are modeled based on a velocity field.

In an example, a velocity field in a fluid is generated using a height field scheme based on a flow of a surface of the fluid, and a movement or a deformation of a target object by interaction between the fluid and the target object is calculated in real time based on the velocity field. Further, by disposing and adding a suitable vortex model to the velocity field in the fluid, influences of target objects, for example, aquatic plants and fish, moving by themselves in the fluid, and indirect interaction between the target objects in the fluid are modeled.

Herein, the term “target object” includes a solid ranging from a rigid body to a deformable body, a general gas such as smoke, and a liquid with high viscosity. The term “fluid” includes a liquid with low viscosity, the liquid capable of interacting with a target object.

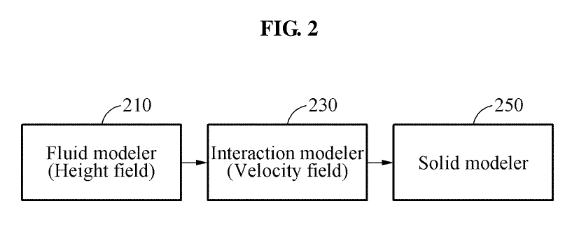

FIG. 2 illustrates an example of a process of transferring an influence of interaction between a fluid and a target object to the target object. Referring to FIG. 2, a fluid modeler 210, an interaction modeler 230, and a solid modeler 250 are illustrated. In the example of FIG. 2, a solid corresponds to a target object.

In general, fluid-solid interaction is performed by calculating a level of influence of a flow of a fluid calculated through fluid modeling on a movement of a solid, and a level of influence of the movement of the solid on the flow of the fluid. In this example, a framework is configured using a two-way interaction scheme such that a movement of a neighboring solid may be influenced by turbulence or a vortex occurring in the fluid due to the movement of the solid.

In an example, the interaction modeler 230 is disposed between the fluid modeler 210 and the solid modeler 250 for interaction between the two. In an example, the fluid modeler 210 is configured to model the fluid based on a height field. The interaction modeler 230 models the interaction by updating a velocity field.

The fluid modeler 210 models the fluid using a height field scheme. The height field scheme is a scheme of modeling only a surface of the fluid, and thus has difficulties in expressing a vortex and turbulence in the fluid. The interaction modeler 230 expresses a vortex occurring in response to the fluid-solid interaction.

The interaction modeler 230 expresses mutual influences between the fluid and the solid using a velocity field of the fluid. To obtain the velocity field in the fluid during the mutual interaction between the fluid and the solid, the interaction modeler 230 reflects or updates, in the velocity field, a vortex model occurring in the fluid.

The solid modeler 250 models a movement of the target object. The solid modeler 250 receives, from the interaction modeler 230, a momentum generated by a velocity of the fluid in the velocity field existing at the same position as the target object, and models the movement of the target object caused by the interaction with the fluid.

In this example, the interaction modeler 230 influences the target object by updating an effect of the vortex in the velocity field in a form of a patch, the vortex occurring during the interaction between the fluid and the target object in the height field. In an example, the velocity field of the interaction modeler 230 is reflected by calculating an overall velocity in the fluid from a velocity profile of the surface of the fluid modeled by the fluid modeler 210, and adding the effect of the vortex occurring in response to the interaction between the fluid and the target object as a velocity variance. A value of the velocity field in the fluid calculated by the interaction modeler 230 is transferred in a form of momentum during the interaction with the target object, and used as an input value to model the movement of the target object.

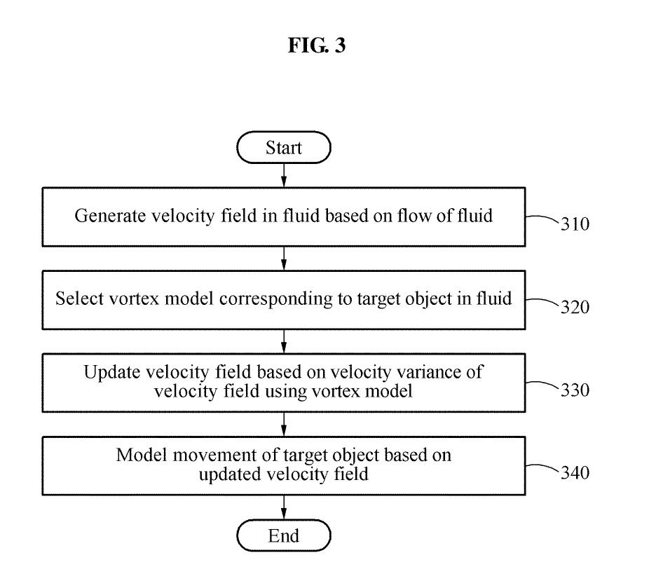

FIG. 3 is a diagram illustrating an example of a method of modeling a movement of a target object. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently. In addition to the description of FIG. 3 below, the above descriptions of FIGS. 1-2, are also applicable to FIG. 3, and are incorporated herein by reference. Thus, the above description may not be repeated here.

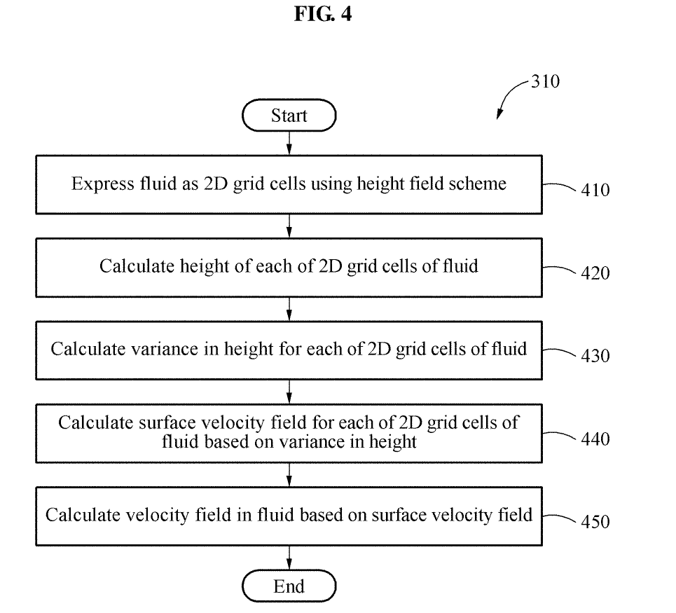

Referring to FIG. 3, in 310, an apparatus for modeling a movement of a target object, hereinafter, the modeling apparatus, generates a velocity field in a fluid based on a flow of the fluid. Here, the velocity field in the fluid refers to an overall velocity field in the fluid. The modeling apparatus generates the velocity field in the fluid from a flow of a surface of the fluid. The flow of the surface of the fluid is obtained from a modeling result using a height field scheme. A method of generating a velocity field in a fluid using the modeling apparatus will be further described with reference to FIG. 4.

In 320, the modeling apparatus selects a vortex model corresponding to a target object in the fluid. The modeling apparatus selects the vortex model in association with a position of the target object based on one or more of a shape and a size of the target object. In an example, the modeling apparatus determines a position and an intensity of the vortex model based on a relative velocity of the fluid with respect to the movement of the target object.

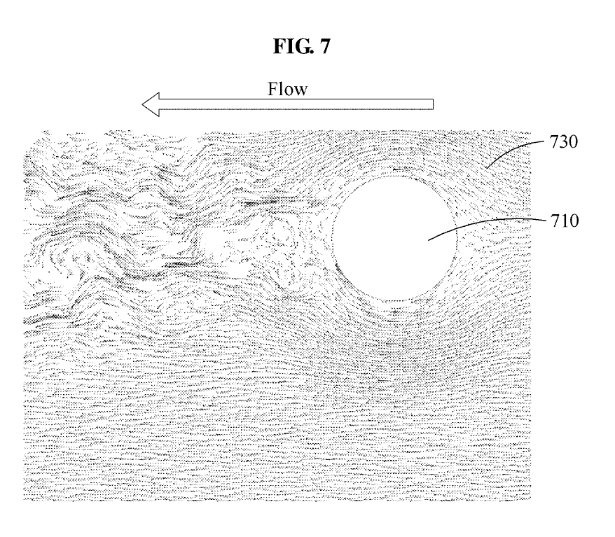

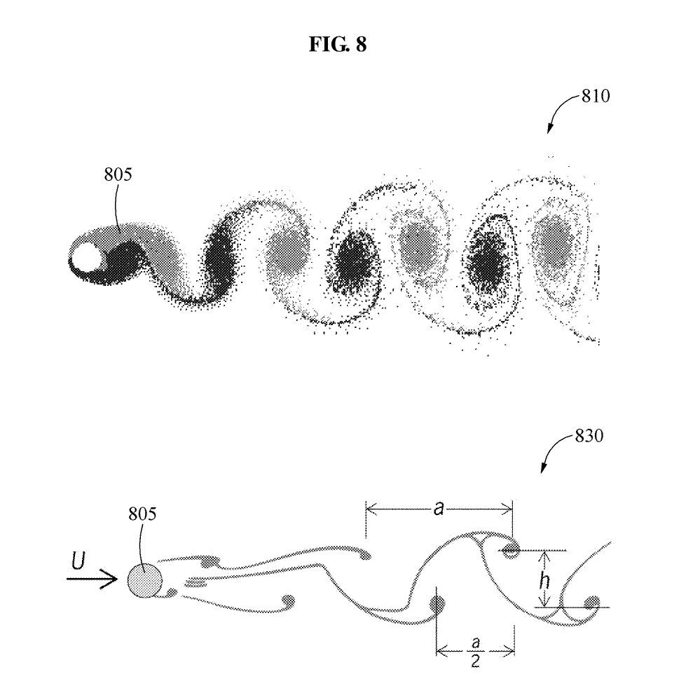

For example, the modeling apparatus selects the vortex model using a curl noise scheme that virtually models fluid turbulence, and a Karman vortex street scheme that models a repeating pattern of vortices. The vortex model selected by the modeling apparatus using the curl noise scheme will be further described with reference to FIG. 7, and the vortex model selected by the modeling apparatus using the Karman vortex street scheme will be further described with reference to FIG. 8.

In 330, the modeling apparatus updates the velocity field based on a velocity variance of the velocity field obtained using the vortex model. The modeling apparatus updates the velocity field by applying the velocity variance of the velocity field to a position in the velocity field, the position corresponding to a position of the target object. In this example, the modeling apparatus updates the velocity field based on the velocity variance using a Gaussian distribution with respect to the target object. For example, the modeling apparatus updates the velocity field by applying a relatively great velocity variance to an area adjacent to an area in which interaction with the fluid occurs, and a relatively small velocity variance to an area distant from the area in which interaction with the fluid occurs using the Gaussian distribution with respect to the position of the target object.

In 340, the modeling apparatus models a movement of the target object based on the updated velocity field.

FIG. 4 is a diagram illustrating an example of a method of generating a velocity field in a fluid. The operations in FIG. 4 may be performed in the sequence and manner as shown, although the order of some operations may be changed or some of the operations omitted without departing from the spirit and scope of the illustrative examples described. Many of the operations shown in FIG. 4 may be performed in parallel or concurrently. In addition to the description of FIG. 4 below, the above descriptions of FIGS. 1-3, are also applicable to FIG. 4, and are incorporated herein by reference. Thus, the above description may not be repeated here. Referring to FIG. 4, in 410, a modeling apparatus expresses a three-dimensional (3D) fluid as two-dimensional (2D) grid cells using a height field scheme.

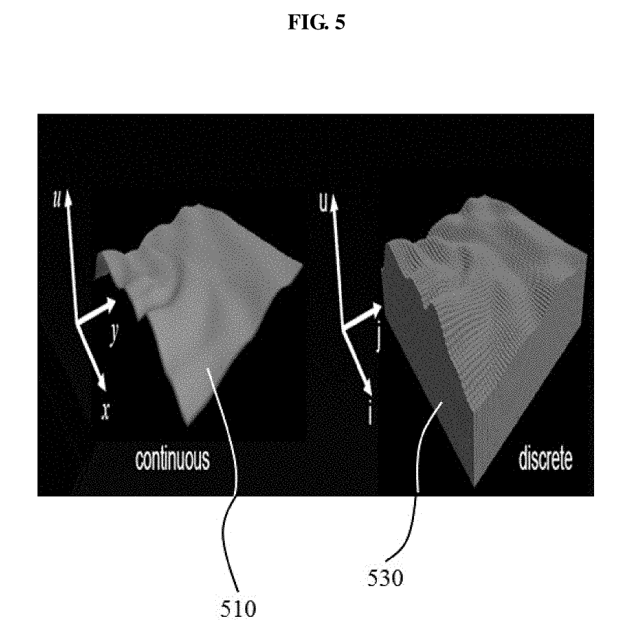

In 420, the modeling apparatus calculates a height of each of the 2D grid cells of the fluid. In 430, the modeling apparatus calculates a variance in the height. 2D grid cells expressed by the modeling apparatus will be further described with reference to FIG. 5.

In 440, the modeling apparatus calculates a surface velocity field of each of the 2D grid cells of the fluid based on the variance in the height.

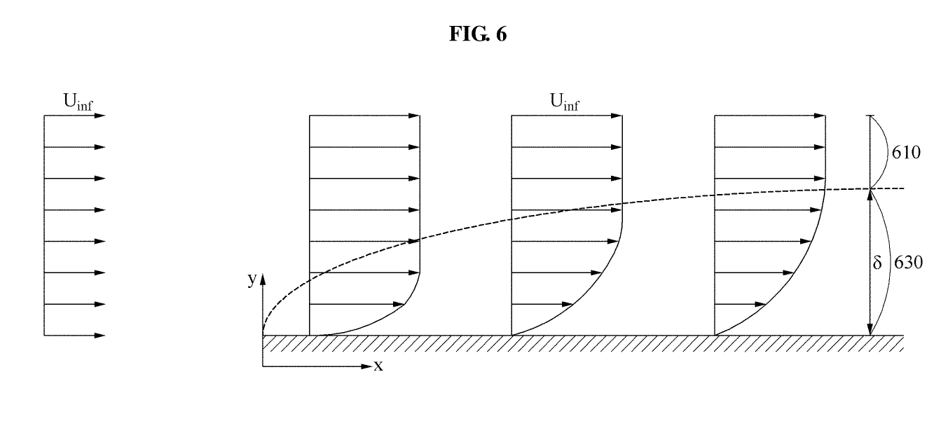

In 450, the modeling apparatus calculates a velocity field in the fluid based on the surface velocity field. A method of calculating a velocity field in a fluid using the modeling apparatus will be further described with reference to FIG. 6.

FIG. 5 illustrates an example of a 3D fluid expressed as 2D grid cells using a height field scheme. Referring to FIG. 5, a three-dimensionally modeled fluid 510 and 2D grid cells 530 of the fluid 510 are illustrated.

In an example, a fluid is modeled using a height field scheme, which models a fluid in real time by calculating a height of a surface of the fluid. The height field scheme divides a 2D space, for example, an x-y plane, corresponding to the surface of the fluid into 2D grid cells, and models the movement of the entire fluid based on variances in height of the 2D grid cells to express a movement of the fluid in a 3D space.

The height field scheme decreases a computing time by decreasing a degree of freedom (DOF) and a dimension of the fluid. In this example, x-y directional velocities in the 2D grid cells are equal.

FIG. 6 illustrates an example of a method of calculating a velocity field in a fluid based on a surface velocity field. Referring to FIG. 6, a surface area 610 to which a velocity field of a surface of a fluid is applied and an inner area 630 to which a velocity field in the fluid is applied are illustrated.

The velocity field in the fluid is obtained as described below. In FIG. 6, U_{inf} denotes a velocity on the surface of the fluid, for example, a surface velocity, and it is assumed that a ground or a plate exists under the surface of the fluid.

A modeling apparatus defines a height 8 from the ground as a thickness of a boundary layer. In this example, the surface of the fluid and an inside of the fluid are distinguished based on the thickness of the boundary layer. An upper side of the boundary layer corresponds to the surface area 610, and a lower side of the boundary layer corresponds to the inner area 630.

The surface area 610 has a velocity equal to the surface velocity U_{nif}. In this example, the thickness of the boundary layer is calculated using functions of a viscosity, a density, a velocity, and an overall scale of the fluid, for example.

The modeling apparatus generates a velocity field in the fluid from the surface velocity field based on the thickness of the boundary layer. The modeling apparatus generate the velocity field in the fluid such that the velocity in the fluid may increase in proportion to a square of a vertical height from the ground. The velocity in the fluid may be equal to the surface velocity U_{nif} at a predetermined or greater height at which the velocity in the fluid is equal to the surface velocity U_{inf} of the surface area 610.

In the fluid, a laminar flow and a turbulent flow occur, for example. The laminar flow is an averaged uniform flow, which maintains a horizontal direction. The laminar flow occurs when a boundary of the fluid is considerably even, a velocity of flow is slow, and a molecular viscosity of the fluid is considerably great, like honey.

The turbulent flow is a flow of the fluid having each portion performing a temporally or spatially non-uniform movement. The laminar flow changes into the turbulent flow when an obstacle is encountered. A number of vortices exist non-uniformly in the turbulent flow. When compared to the laminar flow, the turbulent flow has a relatively greater transport coefficient and applies a relatively greater resistance to an object. The turbulent flow occurs when the boundary of the fluid is uneven, the velocity of flow is fast, and the viscosity of the fluid is small. In an example, the modeling apparatus calculates the velocity field in the fluid differently with respect to the laminar flow and the turbulent flow.

FIGS. 7 and 8 illustrate examples of vortex models being selected.

In response to a velocity field in a fluid being calculated, a modeling apparatus disposes, at a suitable position in the fluid, a vortex model occurring when the fluid interacts with a target object. In an example, the position at which the vortex model is disposed and an intensity when determining the vortex model are expressed using a function of a relative velocity of the fluid with respect to a movement of the target object. In an example, the intensity when determining the vortex model refers to a rotation velocity or a rotation intensity of the vortex model.

In an example, the vortex model is selected using a curl noise scheme being a modeling scheme that virtually generates fluid turbulence, or using a Karman vortex street scheme that models a repeating pattern of vortices.

Referring to FIG. 7, a vortex model selected using the curl noise scheme is illustrated. For example, in a case in which a circular target object 710 exists in a fluid 730, and the fluid 730 flows from right to left, vortices are generated behind the target object 710. In this example, the vortices are generated to be suitable for a geometric structure scale of the target object 710.

Movements of the vortices generated in FIG. 7 are modeled by a curl of a potential field \vec{ψ}=(ψₓ,ψ_{y},ψ_{z}) obtained with respect to directions x, y, and z using Equation 1.

$$\vec{v} ( x , y , z ) = ( \frac{\partial {ψ}_{3}}{\partial y} - \frac{\partial {ψ}_{2}}{\partial z} , \frac{\partial {ψ}_{1}}{\partial z} - \frac{\partial {ψ}_{3}}{\partial x} , \frac{\partial {ψ}_{2}}{\partial x} - \frac{\partial {ψ}_{1}}{\partial y} ) \qquad [ Equation 1 ]$$

In Equation \vec{v}(x,y,z) denotes a velocity of a fluid influenced by a vortex.

In Equation 1, a vector obtained by applying a curl to a potential field denotes the velocity of the fluid influenced by the vortex.

In Equation 1, the potential field \vec{ψ} is expressed by Equation 2.

$$\vec{ψ} = {\sum }_{i} {a}_{i} ramp ( \frac{d ( x )}{{d}_{i}} ) N ( \frac{x}{{d}_{i}} , \frac{t}{{d}_{i}} ) \qquad [ Equation 2 ]$$

In Equation 2, aᵢ denotes a coefficient indicating whether a current position x to obtain the velocity of the fluid is present inside or outside the vortex model. N denotes Perlin noise, and d(x) denotes a distance. d(x) is obtained by (center of target object−position of vortex model)−radius of target object. dᵢ denotes a vortex length, and for example, has a value corresponding to five times the radius of the target object.

ramp(r) denotes a smooth ramp, and has a value as expressed by Equation 3.

$$ramp ( r ) = \{ \begin{matrix}1 \text{:} & r \geq 1 \\ \frac{15}{8} r - \frac{10}{8} {r}^{3} + \frac{15}{8} {r}^{5} \text{:} & 1 > r > - 1 \\ - 1 \text{:} & r \leq - 1\end{matrix} \qquad [ Equation 3 ]$$

An example of a vortex model selected using the Karman vortex street scheme is illustrated in FIG. 8.

A Karman vortex street is a phenomenon in which vortices are generated at both ends of a target object placed in a fluid and propagated downwind. In an example, the vortices generated at both the ends of the object are not aligned. In another example, the vortices are regularly generated on both sides of the object in opposite directions, as shown in a vortex model 810.

When V denotes a velocity of the fluid, v denotes a viscosity of the fluid, and f(a/Δt) denotes a movement frequency of the vortex model 810 occurring repeatedly, the movement of the vortex model 810 is expressed by Equation 4.

$$f = 0.198 ( 1 - \frac{19.7}{Re} ) ( \frac{V}{d} ) , Re = \frac{Vd}{v} \qquad [ Equation 4 ]$$

In Equation 4, d denotes a width of a deformable body interacting with the fluid. In an example, d is obtained by center of target object−position of vortex model. Re denotes a Reynolds number.

For example, when a target object 805 interacts with the fluid, the movement of the vortex model 810 is simplified as shown in an image 830.

In image 830, regular vortices alternately occurring in opposite directions on a downstream of a circumference are stabilized in response to a distance a between vertices and a columnar height h between vertices satisfying a relationship of h/a=0.281.

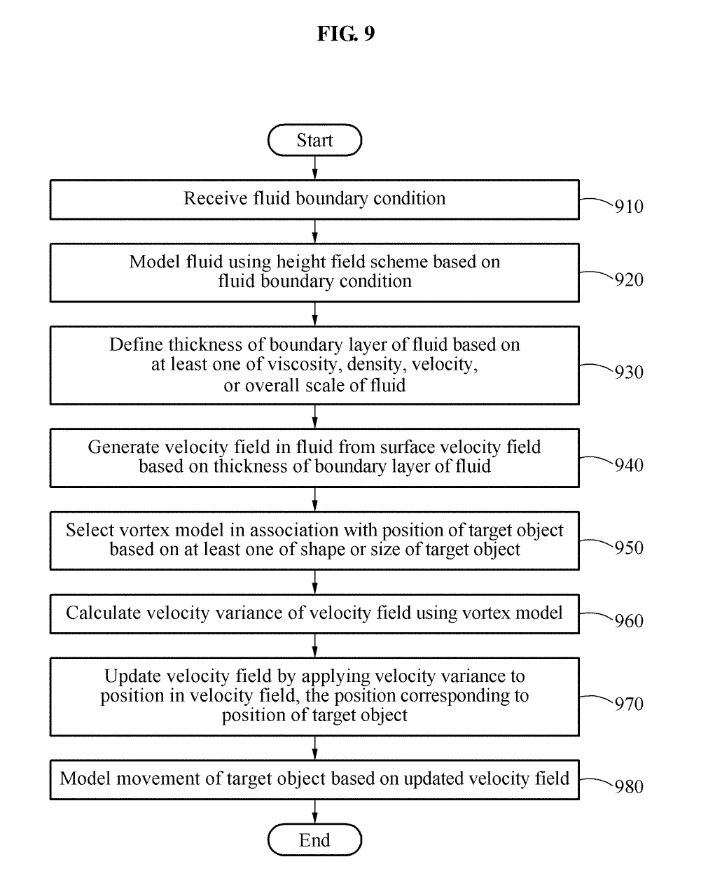

FIG. 9 is a diagram illustrating an example of a method of modeling a movement of a target object. The operations in FIG. 9 may be performed in the sequence and manner as shown, although the order of some operations may be changed or some of the operations omitted without departing from the spirit and scope of the illustrative examples described. Many of the operations shown in FIG. 9 may be performed in parallel or concurrently. In addition to the description of FIG. 9 below, the above descriptions of FIGS. 1-8, are also applicable to FIG. 9, and are incorporated herein by reference. Thus, the above description may not be repeated here.

Referring to FIG. 9, in 910, a modeling apparatus receives a fluid boundary condition. In 920, the modeling apparatus models a fluid based on the fluid boundary condition using a height field scheme. In an example, the fluid boundary condition is preset or input from a user.

In 930, the modeling apparatus defines a thickness of a boundary layer of the fluid based on at least one of a viscosity, a density, a velocity, or an overall scale of the fluid.

In 940, the modeling apparatus generates a velocity field in the fluid from a surface velocity field based on the thickness of the boundary layer of the fluid.

In 950, the modeling apparatus selects a vortex model in association with a position of a target object based on at least one of a shape or a size of the target object.

In 960, the modeling apparatus calculates a velocity variance of the velocity field using the vortex model.

In 970, the modeling apparatus updates the velocity field by applying the velocity variance to a position in the velocity field, the position corresponding to the position of the target object.

In 980, the modeling apparatus models a movement of the target object by interaction with the fluid based on the updated velocity field.

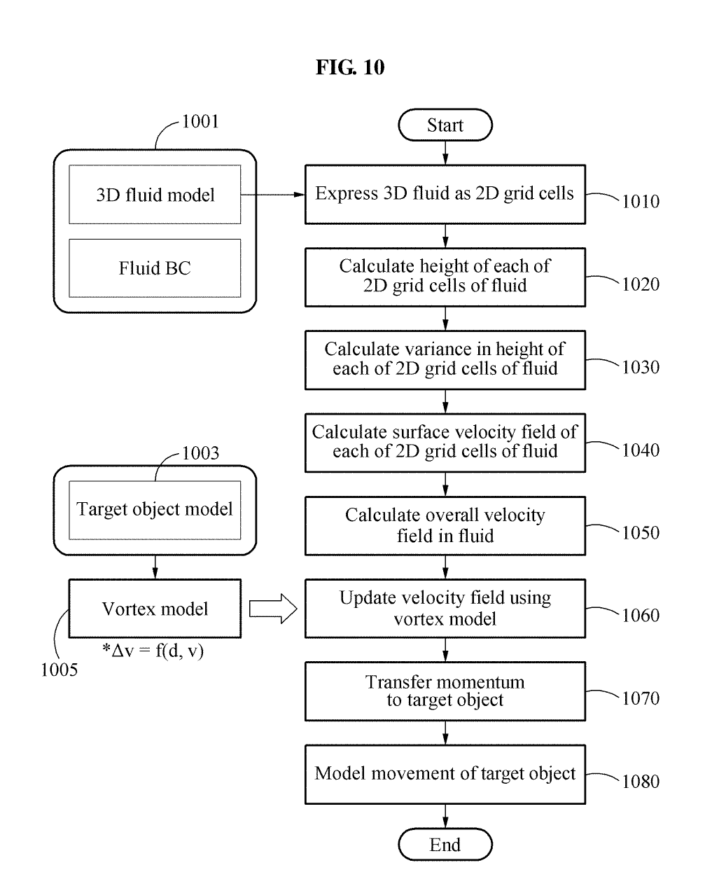

FIG. 10 illustrates an example of a method of modeling a movement of a target object. The operations in FIG. 10 may be performed in the sequence and manner as shown, although the order of some operations may be changed or some of the operations omitted without departing from the spirit and scope of the illustrative examples described. Many of the operations shown in FIG. 10 may be performed in parallel or concurrently. In addition to the description of FIG. 10 below, the above descriptions of FIGS. 1-9, are also applicable to FIG. 10, and are incorporated herein by reference. Thus, the above description may not be repeated here.

Referring to FIG. 10, in 1001, a modeling apparatus receives a 3D fluid model modeled based on a fluid boundary condition (BC). In this example, the fluid BC or a movement of the 3D fluid model is controlled by a user. In an example, the user provides the fluid BC or controls the movement of the 3D fluid model by shaking a mobile device, touching a display, or moving a head while wearing an head mounted device (HMD).

In 1010, the modeling apparatus expresses the 3D fluid model as 2D grid cells. In 1020, the modeling apparatus calculates a height of each of the 2D grid cells of the fluid. In 1030, the modeling apparatus calculates a variance in the height.

In 1040, the modeling apparatus calculates a surface velocity field of each of the 2D grid cells of the fluid. In 1050, the modeling apparatus calculates an overall velocity field in the fluid.

In 1060, the modeling apparatus updates the velocity field using a vortex model 1005. The modeling apparatus updates the velocity field by calculating a velocity variance Δv of the velocity field using the vortex model 1005 and applying the velocity variance to a corresponding position in the velocity field of the fluid. For example, the velocity variance Δv of the velocity field is obtained using a function of a movement frequency f of the vortex model 1005 and a width d of a geometric shape of a target object model 1003. The vortex model 1005 is selected based on a shape and a size of the 3D target object model 1003. The position of the vortex model 1005 is determined in association with the position of the target object model 1003 in the velocity field of the fluid.

In an example, the movement of the 3D target object model 1003 is controlled based on a user input through the modeling apparatus or a device external to the modeling apparatus. For example, the user controls the movement of the target object model 1003 by leaning the head from side to side or lowering the head while wearing an HMD, manipulating a keyboard or a joystick of a game console in real time, shaking a mobile device, or touching or pressing a display of the mobile device.

In 1070, the modeling apparatus transfers a momentum or the velocity variance to the target object based on the updated velocity field. In 1080, the modeling apparatus models the movement of the target object by interaction with the fluid.

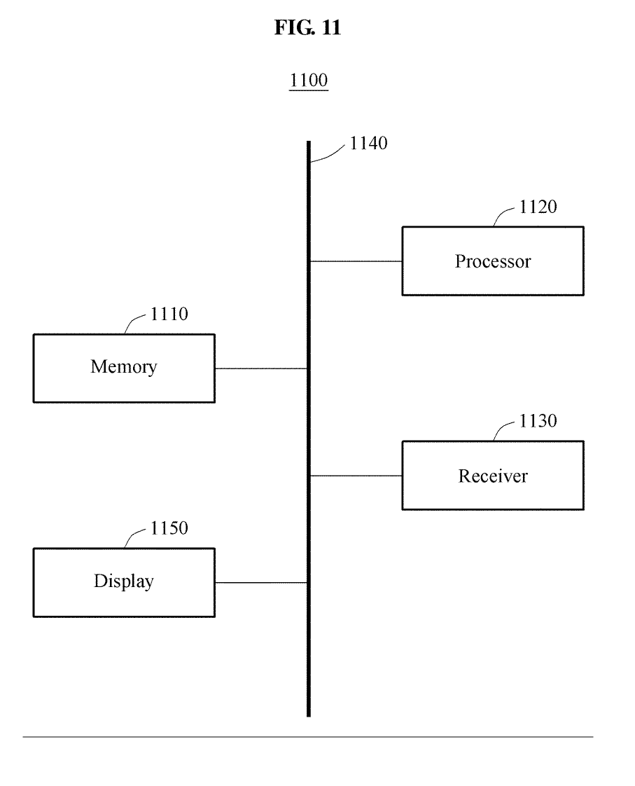

FIG. 11 is a diagram illustrating an example of an apparatus for modeling a movement of a target object. Referring to FIG. 11, a modeling apparatus 1100 includes a memory 1110 and a processor 1120. The modeling apparatus 1100 further includes a receiver 1130 and a display 1150. The memory 1110, the processor 1120, and the receiver 1130 communicate with one another through a bus 1140. While components related to the present example are illustrated in the modeling apparatus 1100 of FIG. 11, it is understood that those skilled in the art may include other general components, such as, for example, an input/output device.

The memory 1110 stores a vortex model selected by the processor 1120, or a velocity variance of a velocity field obtained using the vortex model. The memory 1110 may be a volatile memory or a non-volatile memory.

The processor 1120 generates a velocity field in a fluid based on a flow of the fluid, and selects a vortex model corresponding to a target object in the fluid. The processor 1120 models a movement of the target object based on the velocity field, and the velocity field is updated based on the velocity variance of the velocity field using the vortex model.

The processor 1120 generates the velocity field in the fluid based on a flow of a surface of the fluid obtained from a modeling result using a height field scheme.

The processor 1120 expresses the fluid as 2D grid cells using the height field scheme, and calculates a variance in height of each of the 2D grid cells of the fluid. The processor 1120 calculates the velocity field in the fluid based on a surface velocity field of each of the grid cells of the fluid, the surface velocity field calculated based on the variance in height.

The processor 1120 generates the velocity field in the fluid from the surface velocity field based on a thickness of a boundary layer of the fluid, the thickness of the boundary layer is defined based on at least one of a viscosity, a density, a velocity, or an overall scale of the fluid.

The processor 1120 determines at least one of a position or an intensity of the vortex model based on a relative velocity of the fluid with respect to the movement of the target object.

The processor 1120 updates the velocity field by applying the velocity variance to a position in the velocity field, the position corresponding to a position of the target object.

The processor 1120 updates the velocity field based on the velocity variance using a Gaussian distribution with respect to the target object.

The receiver 1130 receives a fluid boundary condition. The processor 1120 models the fluid using a height field scheme based on the fluid boundary condition. The receiver 1130 receives a user input to control the movement of the target object or the fluid to be modeled.

The processor 1120 performs at least one of the methods described with reference to FIGS. 1 through 10.

The processor 1120 executes an application program and controls the modeling apparatus 1100. A program code executed by the processor 1120 is stored in a non-transitory storage medium, such as, for example, the memory 1110. The modeling apparatus 1100 is connected to an external device, for example, a personal computer or a network, through an input/output device (not shown), and exchanges data with the external device.

In an example, the processor 1120 may model, for example, the fluid using a height field scheme based on the fluid boundary condition, and may display the model on the display 1150. In another example, the processor 1120 may model, for example, a scene in which a fluid and a target object interact and influence each other in real time, and may display the model on the display 1150. In another example, the processor 1120 may provide realistic modeling of smoke turbulence or gas turbulence in real time on the display 1150. The display 1150 may be a physical structure that includes one or more hardware components that provide the ability to render a user interface and/or receive user input. The display 1150 can encompass any combination of display region, gesture capture region, a touch sensitive display, and/or a configurable area. The display 1150 can be embedded in the modeling apparatus 1100 or may be an external peripheral device that may be attached and detached from the modeling apparatus 1100. The display 1150 may be a single-screen or a multi-screen display. A single physical screen can include multiple displays that are managed as separate logical displays permitting different content to be displayed on separate displays although part of the same physical screen. The display 1150 may also be implemented as an eye glass display (EGD), which includes one-eyed glass or two-eyed glasses.

As a non-exhaustive illustration only, the modeling apparatus 1100 may be embedded or interoperate with various digital devices such as, for example, a mobile phone, a cellular phone, a smart phone, a wearable smart device (such as, for example, a ring, a watch, a pair of glasses, glasses-type device, a bracelet, an ankle bracket, a belt, a necklace, an earring, a headband, a helmet, a device embedded in the cloths), a personal computer (PC), a laptop, a notebook, a subnotebook, a netbook, or an ultra-mobile PC (UMPC), a tablet personal computer (tablet), a phablet, a mobile internet device (MID), a personal digital assistant (PDA), an enterprise digital assistant (EDA), a digital camera, a digital video camera, a portable game console, an MP3 player, a portable/personal multimedia player (PMP), a handheld e-book, an ultra mobile personal computer (UMPC), a portable lab-top PC, a global positioning system (GPS) navigation, a personal navigation device or portable navigation device (PND), a handheld game console, an e-book, and devices such as a high definition television (HDTV), an optical disc player, a DVD player, a Blue-ray player, a setup box, robot cleaners, a home appliance, content players, communication systems, image processing systems, graphics processing systems, other consumer electronics/information technology (CE/IT) device, or any other device capable of wireless communication or network communication consistent with that disclosed herein. The digital devices may be implemented in a smart appliance, an intelligent vehicle, or in a smart home system.

The digital devices may also be implemented as a wearable device, which is worn on a body of a user. In one example, a wearable device may be self-mountable on the body of the user, such as, for example, a watch, a bracelet, or as an eye glass display (EGD), which includes one-eyed glass or two-eyed glasses. In another non-exhaustive example, the wearable device may be mounted on the body of the user through an attaching device, such as, for example, attaching a smart phone or a tablet to the arm of a user using an armband, incorporating the wearable device in a cloth of the user, or hanging the wearable device around the neck of a user using a lanyard.

The apparatuses, units, modules, devices, and other components illustrated in the drawings that perform the operations described herein are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 3-4 and 9-10 that perform the operations described herein are performed by computing hardware as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of modeling a movement of an object, the method comprising:
generating a velocity field in a fluid based on a flow of the fluid;
selecting a vortex model corresponding to the object in the fluid;
updating the velocity field based on a velocity variance of the velocity field obtained using the vortex model; and
modeling a movement of the object based on the updated velocity field.

2. The method of claim 1, wherein the generating of the velocity field comprises generating the velocity field based on a flow of a surface of the fluid obtained from a result of modeling using a height field scheme.

3. The method of claim 2, wherein the generating of the velocity field comprises:
expressing the fluid as two-dimensional (2D) grid cells using the height field scheme;
measuring a variance in height of each of the 2D grid cells of the fluid;
ascertaining a surface velocity field of the each of the 2D grid cells of the fluid based on the variance in height; and
determining the velocity field in the fluid based on the surface velocity field.

4. The method of claim 3, wherein the generating of the velocity field comprises:
defining a thickness of a boundary layer of the fluid based on at least one of a viscosity, a density, a velocity, or an overall scale of the fluid; and
generating the velocity field in the fluid from the surface velocity field based on the thickness of the boundary layer of the fluid.

5. The method of claim 1, wherein the selecting of the vortex model comprises selecting the vortex model in association with a position of the target object based on at least one of a shape or a size of the target object.

6. The method of claim 1, wherein the selecting of the vortex model comprises determining at least one of a position or an intensity of the vortex model based on a relative velocity of the fluid with respect to the movement of the target object.

7. The method of claim 1, wherein the selecting of the vortex model comprises selecting the vortex model using at least one of a curl noise scheme that virtually models fluid turbulence or a Karman vortex street scheme that models a repeating pattern of vortices.

8. The method of claim 1, wherein the updating of the velocity field comprises updating the velocity field by applying the velocity variance to a position of the object in the velocity field.

9. The method of claim 8, wherein the updating of the velocity field comprises updating the velocity field based on the velocity variance using a Gaussian distribution with respect to the target object.

10. The method of claim 1, further comprising:
calculating the velocity variance of the velocity field using the vortex model.

11. The method of claim 1, further comprising:
receiving a fluid boundary condition; and
modeling the fluid using a height field scheme based on the fluid boundary condition.

12. A non-transitory computer-readable storage medium having recorded thereon a program to cause a computer to perform the method of claim 1.

13. An apparatus for modeling a movement of an object, the apparatus comprising:
a processor configured to:
generate a velocity field in a fluid based on a flow of the fluid,
select a vortex model corresponding to the object in the fluid, and
model a movement of the object based on the velocity field, the velocity field being updated based on a velocity variance of the velocity field obtained using the vortex model.

14. The apparatus of claim 13, wherein the processor is further configured to generate the velocity field based on a flow of a surface of the fluid obtained from a result of modeling using a height field scheme.

15. The apparatus of claim 14, wherein the processor is further configured to express the fluid as two-dimensional (2D) grid cells using the height field scheme, to measure a variance in height of each of the 2D grid cells of the fluid, to ascertain a surface velocity field of the each of the 2D grid cells of the fluid based on the variance in height and to determine the velocity field in the fluid based on the surface velocity field.

16. The apparatus of claim 15, wherein the processor is further configured to generate the velocity field in the fluid from the surface velocity field based on a thickness of a boundary layer of the fluid, the thickness of the boundary layer being defined based on at least one of a viscosity, a density, a velocity, or an overall scale of the fluid.

17. The apparatus of claim 13, wherein the processor is further configured to determine at least one of a position or an intensity of the vortex model based on a relative velocity of the fluid with respect to the movement of the object.

18. The apparatus of claim 13, wherein the processor is further configured to update the velocity field by applying the velocity variance to a position of the object.

19. The apparatus of claim 18, wherein the processor is further configured to update the velocity field based on the velocity variance using a Gaussian distribution with respect to the object.

20. The apparatus of claim 13, further comprising:
a receiver configured to receive a fluid boundary condition,
wherein the processor is further configured to model the fluid using a height field scheme based on the fluid boundary condition.
